(19) United States
(12) Patent Application Publication
(10) Pub. No.: US 2005/0021395 A1
(43) Pub. Date: Jan. 27, 2005

(54) System and method for conducting an advertising campaign

(76) Inventor: Duc Thong Luu, San Jose, CA (US)

Correspondence Address: James J. DeCarlo;Stroock & Stroock & Lavan LLP, 180 Maiden Lane, New York, NY, 10038, US

(21) Appl. No.: 10/620,494

(22) Filed: Jul. 16, 2003

Related U.S. Application Data
(60) Provisional application No. 60/449,805, filed on Feb. 24, 2003.

(51) Int. Cl. G06F 17/60

(52) U.S. Cl. 705/14

(57) ABSTRACT

A method of recognizing revenue for a Web advertising reach and frequency campaign can comprise specifying a target Gross Rating Point (GRP) for one or more lines of the advertising campaign. The method can further comprise specifying a total booked amount of money for the lines, and apportioning the target GRP among one or more time periods of the campaign for the lines. The method can further comprise apportioning the total booked amount among the time periods, wherein the revenue is based on the apportioned GRP and the apportioned booked amount.

### CROSS-REFERENCE TO RELATED APPLICATION

This application claims the benefit of U.S. Provisional Patent Application No. 60/449,805, filed Feb. 24, 2003, entitled “System and Method for Conducting a Marketing Campaign,” which is hereby incorporated by reference herein.

### BACKGROUND OF THE INVENTION

1. Field of the Invention

The invention relates generally to online advertising, and, more particularly, to a system and method for conducting an online advertising campaign.

2. Description of Related Art

Advertising over the Internet and World Wide Web (“Web”) has become increasingly popular. Many advertisers have found that advertising their products or services over the Internet can be very productive and beneficial. Indeed, when accessing or “surfing” the Web, a user will typically encounter various advertisements, or ads, while accessing various Web sites. These advertisements, or ads, may take the form of banner ads, pop-up ads, interstitials, frame ads, or other forms.

Consequently, Web service providers such as, for example, Internet Service Providers, Internet search engine companies, Internet advertising companies, and other entities have begun to aggressively pursue customers to purchase Web advertising. Web advertising is sold on a “Cost Per Impressions” (“CPI”) or “Cost per Thousand Impressions” (“CPM”) basis. Generally, an impression occurs when a person visits or displays a Web page having an advertisement. For example, an advertiser may arrange to have an advertising campaign include one-hundred-thousand impressions for $500,000.00, or a CPM of $5.00. Another method of selling Web advertising is on a “Cost Per Click-through” (“CPC”) basis. A click-through occurs when a visitor to a Web site activates or clicks on an ad, thereby “clicking through” from the ad directly to the advertiser's Web site. Some advertisers believe that click-throughs are a better measurement of the effectiveness of an ad because it measures how many visitors actively pursue information regarding an advertised product or service, instead of just passively viewing the ad. Another method of measuring Web advertisements is by counting acquisitions. Generally, an acquisition occurs when a customer actually makes a purchase from a Web advertisement.

Many advertisers, however, are not familiar or comfortable with these relatively new methods of purchasing advertising for their advertising campaigns. These advertisers are more familiar with purchasing advertising through more traditional media, such as print magazines and television. Television networks typically sell advertising based on units of 30 seconds of time; print magazines often sell advertising based on units of an issue of a magazine. Presently, Web advertisers do not have an easily tracked unit for selling advertising that corresponds to the 30-second “spot” on television, or the single issue of a magazine.

Furthermore, traditional media often employ an advertising buying model that is audience-based. With an audience-based buying model, advertisers direct their campaigns to specific targeted audiences based upon certain demographics of those audiences. For example, an advertiser, such as a beverage company, may target males between the ages of 18 and 25 who enjoy watching professional football on television.

To plan ahead for, and also to measure the effectiveness of, their traditional media advertising campaigns, many advertisers use audience metrics in the context of Reach and Frequency and the Gross Rating Point (“GRP”). Generally, Reach is the percent or number of audience members of a specific population that view an advertisement. Frequency is the number of times members of a specific population are exposed to an advertisement. A Rating point is equal to a Reach of one percent of a target audience. Therefore, in general, GRP=Reach×Frequency.

When an advertiser desires to design a marketing campaign to target a specific audience, he may choose to strive, for example, for 10 GRPs with a full-page ad in an issue of a weekly magazine. If the ad costs the advertiser $50,000, and 10 GRPs are achieved, the Cost Per Point (“CPP”) for that advertisement would be $50,000/10 or $5,000.

Because of their familiarity with the way that audiences for traditional media are measured (viewership for television programs, and readership for magazines) and from their experience over the years of what type of advertising will achieve a certain GRP and a certain audience response, advertisers have become comfortable with purchasing advertising through traditional media. In other words, due to familiarity with the various metrics used in purchasing and measuring the effect of advertising in traditional media, advertisers feel comfortable that they are getting value for what they pay for, and that the value received can be accurately measured and quantified. Accordingly, if the results are not as expected, advertisers are confident that the advertising campaign may be modified or fine-tuned such that the desired results will be achieved.

In contrast, for a variety of reasons, some advertisers do not have the same level of confidence with the metrics related to Web advertising that they do with advertising in traditional media. Some of the reasons for this lack of confidence are the relative newness of the Web as an advertising medium, and a general uncertainty of the effectiveness of Web advertising in the wake of the demise of many Web-based companies. Another cause of lack of confidence in including Web advertising in their advertising campaigns is the lack of understanding, and unfamiliarity with, purchasing advertising based on the CPI model. Accordingly, many advertisers have avoided the use of Web advertising as a component of their advertising campaigns.

Consequently, in an attempt to overcome the lack of confidence in Web advertising metrics, and to attract more advertisers, some Service Providers have experimented with using metrics more similar to those used by traditional media, such as Reach, Frequency and GRPs, in selling Web advertising. Typically, a certain number of GRPs is purchased over the length of an advertising campaign. The use of this type of system, however, may result in GRPs that are higher than expected. At the end of the campaign, when the GRPs are tabulated, the desired GRP level may not have been reached, causing advertiser dissatisfaction. On the other hand, in some cases, an over delivery may occur, with the Web advertising company not receiving fair compensation for the GRP delivered.

Accordingly, there is a need for an improved method of conducting a Web advertising campaign that instills familiarity and confidence in advertisers, and preferably that is fair to both the advertisers and Web service providers. As such, a need exists for an improved system and method for conducting a Web advertising campaign.

### SUMMARY OF THE INVENTION

The present invention satisfies these and other needs. Various embodiments of the present invention provide for systems and methods for conducting a Web advertising campaign. Such systems and methods support various aspects of the advertising campaign such as booking the campaign, recognizing the revenue earned from the campaign and recording details of revenue types, providing information for managing the campaign, and invoicing customers.

One embodiment of the invention is directed to a system and method wherein an advertising contract contains one or more individual lines. Each line specifies any one or more of the following criteria: the particular ad; the Web property on which the ad is to appear; start date; end date/duration; pricing (i.e., booked amount of money); GRP; and the like. The advertising characteristics for any one line, such as start date, end date, booked amount of money, and target GRP are separate and independent from those of any other line. Further, maintenance of the advertising campaign can be performed at a line level. Accordingly, revenues can be calculated and recognized on a line-by-line basis, and under delivery or over delivery may be analyzed on a line-by-line basis.

More specifically, each line can have a start date and an end date, which determine the length of the individual campaign of that particular line. Each line also has a total booked amount of money for that particular line. Each line also has a target GRP associated with it.

More specifically, the price, or amount booked, for each line over the duration of the line and the GRP for each line are apportioned, for example, on a periodic, such as weekly, basis. For each week of the line campaign, the service provider analyzes the actual GRP received by the particular line, and compares that value with the target GRP value. In the case of an under-delivery, where the actual GRP is less than that of the target GRP, the service provider only receives credit for bookings in proportion to the ratio of actual GRP to target GRP. In the case of an over-delivery, where the actual GRP is greater than the target GRP, the service provider receives credit for the bookings allocated to that week. In other embodiments, the service provider receives an amount in excess to the allocated bookings in proportion to the ratio that the actual GRP exceeds the target GRP. In certain of these embodiments, the service provider's actual bookings are capped at the total price and/or at the monthly allocated bookings.

A embodiment of method of recognizing revenue for a Web advertising reach and frequency campaign can comprise specifying a target Gross Rating Point (GRP) for one or more lines of the advertising campaign. The method can further comprise specifying a total booked amount of money for the lines, and apportioning the target GRP among one or more time periods of the campaign for the lines. The method can further comprise apportioning the total booked amount among the time periods, wherein the revenue is based on the apportioned GRP and the apportioned booked amount.

Thus, the system and method for conducting an advertising campaign as described herein may facilitate booking, revenue recognition, management and billing of a Web advertising campaign. Moreover, the Web advertising campaign is conducted such that the related revenue calculations are consistent, fair and meaningful to client advertisers.

Other objects and features of the present invention will become apparent from the following detailed description, considered in conjunction with the accompanying drawing figures. It is understood, however, that the drawings are provided solely for the purpose of illustration and not as a definition of the limits of the invention, for which reference should be made to the appended claims.

### BRIEF DESCRIPTION OF THE DRAWING FIGURES

In the drawing figures, which are merely illustrative, and wherein like reference numerals depict like elements throughout the several views:

FIG. 1 is an illustrative system diagram of an overview of an embodiment of an advertising system in accordance with the present invention;

FIG. 2 is a chart illustrating exemplary methods of revenue recognition in accordance with the present invention;

FIGS. 3a and 3b are charts illustrating exemplary methods of revenue recognition in accordance with the present invention;

FIG. 4 is a system block diagram of an embodiment of an advertising system in accordance with the present invention;

FIG. 5 is an illustrative system diagram of an embodiment of an advertising system in accordance with the present invention; and

FIGS. 6a-6i are screen shots illustrating the entry of advertising campaign data in accordance with an embodiment of the invention.

### DETAILED DESCRIPTION OF EXEMPLARY EMBODIMENTS

There will now be shown and described in connection with the attached drawing figures several exemplary embodiments of a system and method for conducting a marketing campaign.

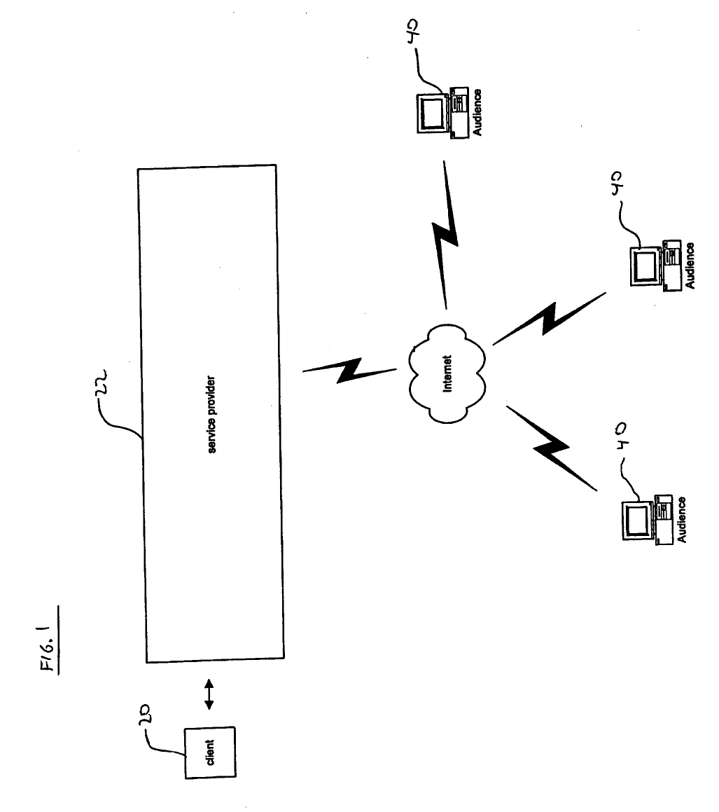

With reference to FIG. 1, there is shown an overview of an embodiment of a system for conducting an advertising campaign in accordance with the present invention. In certain embodiments of the invention, one or more advertising clients 20 seek to run a Web advertising campaign. Advertising client 20 may be a traditional “brick and mortar” company, an Internet-based company, or any other company or entity desiring to advertise its products or services.

As discussed in greater detail below, Web service provider 22 contracts with client 20 generally to plan, negotiate, schedule, track and bill for a Web advertising campaign. Web service provider 22 may be, for example, an Internet Service Provider, such as America Online, Inc., an on-line consumer and business services company, such as Yahoo! Inc., or an Internet advertising company, such as DoubleClick, Inc.

Once the advertising campaign is booked, the service provider 22 serves the ads via the Internet in accordance with its agreement with client 20. Users of the Internet, including members of the target audience 40, view the ads while accessing Web pages via their respective audience computers or other device. The service provider 22 tracks various metrics related to the ads and their exposure to the audience members 40.

Prior to initiating the campaign, the client 20 and the service provider 22 discuss and negotiate a sales or advertising contract. The advertising contract contains one or more individual lines. Each line is associated with a Reach and Frequency (RF) group (although, in certain embodiments, a hybrid contract may exist wherein certain lines are associated with an RF group, while other lines are associated with other revenue recognition methods, such as CPI or CPC, as discussed above). As such, each line specifies a particular ad to be run and any one or more advertising characteristics. For example, the line may specify the Web page or pages or the Web property or properties on which the ad may run. Alternatively, the Web pages or properties on which the ad will run are not predetermined. A Web property may be a Web page or group of Web pages associated by a single trade name or similar logical commercial grouping, such as, for example, those Web pages associated with Yahoo! Shopping, Yahoo! Sports, and Yahoo! Finance, or a Web property may be a particular Web page or site associated as part of an advertising network, such as that offered by DoubleClick, Inc.

Various metrics or advertising characteristics are associated with each line of the advertising contract, including, for example, the Web pages and/or properties on which the ad should run, a start date and an end date, which determine the length of the individual campaign of that particular line; a total price or amount of money “booked” for that particular line; a target GRP associated with it, which may be determined, in part, by historical records and predictive analysis, as is described in further detail below; and demographic information of the target audience 40, such as territory, gender, and age range. While all of the lines within a single RF group share the same demographic information, in certain embodiments, the advertising characteristics for any one line, such as start date, end date, booked amount of money, and target GRP, are separate and independent from those of any other line. Accordingly, the service provider 22 may track the performance, fulfillment and revenue recognition of each line on an individual basis.

More specifically, revenue is calculated for each line as follows. First, the total target GRP for the line is logically apportioned among each of the weeks of the ad campaign for that particular line. Next, the booked amount of money for the line is also logically apportioned among each of the weeks of the campaign. Next, the service provider 22 analyzes the weekly actual GRP achieved by the particular line, and compares that value with the weekly target GRP value to determine, in a sense, the amount of money “earned” by the service provider 22 for the week. In the case of an under-delivery, where the actual GRP is less than that of the target GRP, the service provider only receives credit for bookings in proportion to the ratio of actual GRP to target GRP. In other words, if only 80 percent of the target GRP for that week is achieved, the service provider 22 only receives credit for 80 percent of the bookings. As stated above, these calculations are made on an individual line-by-line basis.

Because relatively large fluctuations in actual GRP may occur from one week to the next, the service provider 22 invoices the advertising client 20 on a monthly basis. To calculate the amount to be invoiced for a particular line, the actual amount booked for each week during the month is summed. If a week of the ad campaign straddles two months, the relevant actual GRP will be calculated in proportion to the amount of days of that week that are in the month for which the invoice is being generated. For example, if the first three days of a week of an ad campaign fall within a first month, and the last four days of the week fall within a second month, the invoice for the first month will reflect values for three out of the seven days of the week, or 3/7 of the weekly recognized amount. Notably, it can be shown that the calculations of GRP when proceeding from a weekly calculation to a total campaign GRP goal is linear, and thus fair to both the advertising client and the service provider.

While the recognizing of revenue is discussed herein from the viewpoint of revenue to be paid to the service provider 22, alternate embodiments provide for the recognizing of revenue to be that paid to the client 20. Alternatively, portions of the recognized revenue could be paid or charged to both the service provider 22 and the client 20 and/or to other third parties.

In certain embodiments, an over-delivery, where actual GRP for the month is greater than target GRP for the month, for a line may be “carried over” to the next month by the service provider to offset any subsequent monthly under-delivery, where actual GRP for the month is less than the target GRP, for that line. In alternate embodiments, monthly GRP over-delivery may be carried over for two or more months. In the present embodiment, while a monthly under-delivery of GRP will result in the service provider 22 receiving proportionally less revenue, an over-delivery will not result in the service provider 22 recognizing more than the monthly booked amount. In other words, the service provider's monthly recognized revenue is capped at the booked amount. As discussed above, however, the monthly over-delivery may be carried over into a subsequent month. In alternate embodiments of the invention, the capping of the service provider's recognized revenue may take place at the campaign level (with a campaign spanning two or more months), instead of at the monthly level. In alternate embodiments of the method, however, the service provider 22 may recognize more than the monthly booked amount for a given month. In such alternate embodiments, the service provider's monthly recognized revenue is not capped at the booked amount.

The revenue recognition methodology discussed above can also be represented mathematically as follows:

$$\text{Actual Line Revenue per week} = A * \frac{G}{C} \qquad ( Formula 1 )$$

Where,

$$\begin{matrix}A = \text{line booking amount per week} \\ = \frac{line\_amount \_MINUS \_discounts}{no\_of \_weeks}\end{matrix}$$

G=Line actual GRP, i.e., GRP delivered during the week

$$C = Line booked GRP for the week = \frac{line\_GRP}{no\_of \_weeks}$$

As discussed below, when a representative of the Web services provider, such as a Sales Representative (“Sales Rep.”) enters the line, the line becomes populated by advertising characteristic target data. This target data remains unchanged after the line is entered. Accordingly, line booked GRP for the week, or C, may be calculated as follows:

Where:

LB=Line booking amount, i.e., line amount MINUS discounts.

LG=Line GRP.

N=number of weeks.

Then, Formula 1 (shown above) can be rewritten as:

$$\begin{matrix}\text{Actual Line Revenue per week} = \frac{LB}{N} * \frac{G}{\frac{LG}{N}} \\ = G * \frac{LB}{LG}\end{matrix} \\ \text{Actual Line Revenue per week} = G * \frac{LB}{LG} \qquad ( Formula 2 )$$

Where:

G=Line actual GRP, i.e., GRP delivered during the week

LB=Line booking amount, i.e., line amount MINUS discounts.

LG=Line GRP

Notably, Formula 2 provides for a calculation different than does Formula 1 because it does not rely upon booking amount per week or per month, and as such, represents an alternate implementation methodology.

In a preferred embodiment, G (Line Actual weekly GRP) and LG (Line GRP) are saved with at least four significant figures after the decimal point. The use of four significant figures after the decimal point provides that, after rounding off, the result is reliable up to 2 significant figures after the decimal point, and thus to an amount corresponding to the cent of the U.S. dollar or the Euro.

In an embodiment of the present invention, the process for calculating revenue earned from a line over a period of time, such as N weeks, is as follows.

As a direct consequence from Formula 2 (listed above):

$$Actual Line Revenue over N weeks = \frac{LB}{LG} {\sum }_{i = 1}^{N} {G}_{i} \qquad ( Formula 3 )$$

Where:

Gᵢ=Line Actual GRP of the i^{th} week.

LB=Line booking amount, i.e., line amount−discounts.

LG=Line GRP.

For a partial week, the amount will be directly proportional to the ratio of actual days to days in the week.

The Estimated Revenue can be calculated as follows. The Estimated Revenue can be used, for example, in situations where a revenue amount is to be used for a certain time period, but data for actual revenue for the entirety of that period has not been determined. This revenue is an estimate of money to be earned until the end of month, in addition to actual revenue. This revenue is proportional with the ratio of:

$$\frac{Days\_left \_until \_end \_of \_month}{Days\_with \_actual \_revenue}$$

In a preferred embodiment, the “Days left until end of month” is counted from the Monday of the first week that does not have statistical data. If, on the day revenue recognition is run, there are zero days with actual revenue, the amounts recognized will be as follows: 1) Zero dollars for Actual Revenue; and 2) 90% of the booking amount for Estimate Revenue. If the Actual Revenue already exceeds the monthly booking, the Estimate will still be calculated.

As noted above, certain embodiments permit an over-delivery to be carried over and applied to a subsequent time period. Similarly, under-delivery may be applied to subsequent periods. Thus, in certain embodiments, none, one or both of over-delivery and under-delivery are applied to subsequent periods.

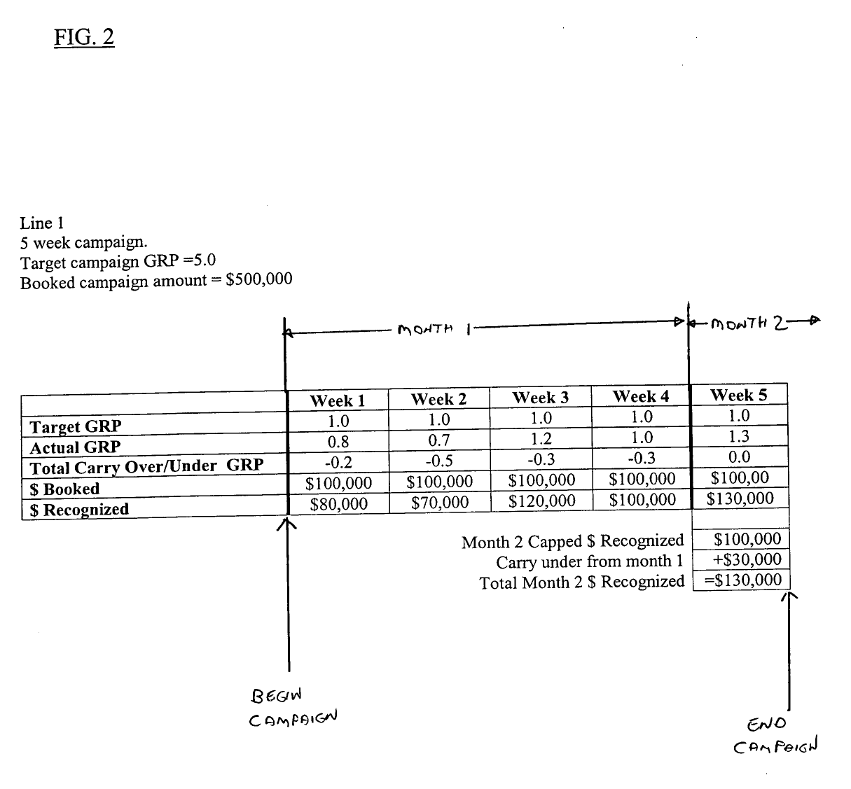

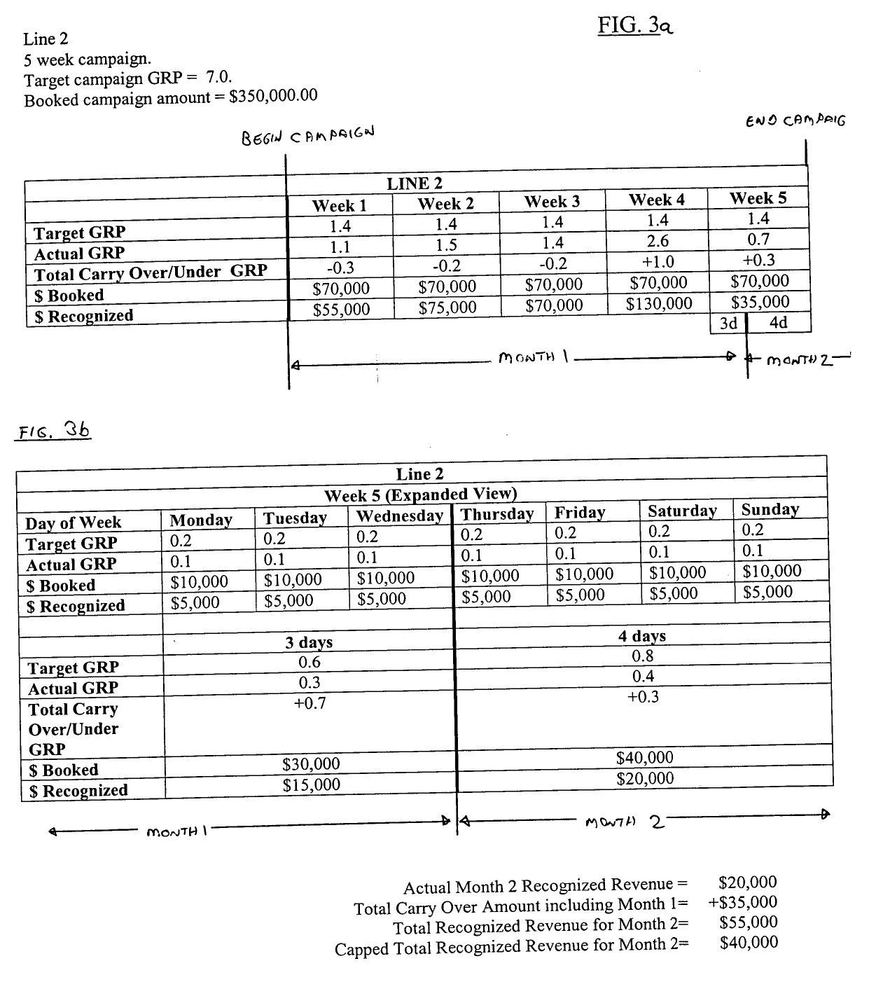

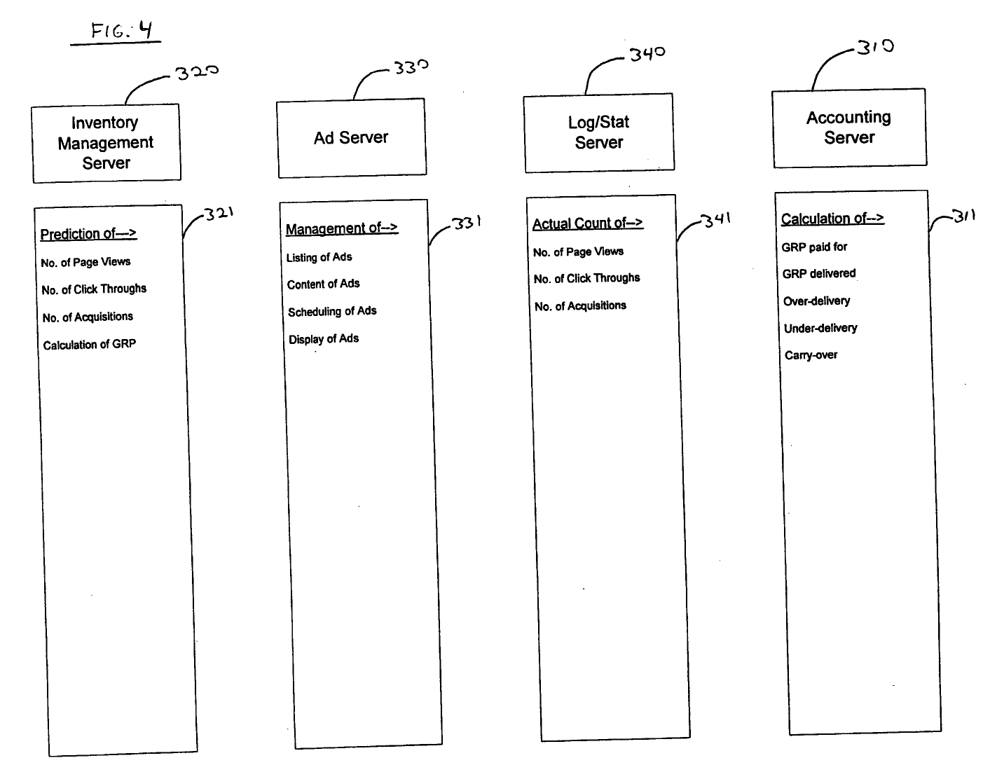

Illustrative examples of embodiments in which weekly carry-overs and carry-unders are given effect will now be described with reference to FIGS. 2, 3a and 3b.

With reference to FIG. 2, in which an exemplary carry-under is described, there is shown an illustrative example of data pertaining to a line (Line 1) of an advertising contract. Line 1 is a campaign having a duration of 5 weeks. The target GRP for the line is 5.0. The booked campaign amount is $500,000. First, the total GRP for the line campaign (5.0) is apportioned equally among the weeks of the ad campaign (5 weeks), resulting in a weekly target GRP of 1.0. Next, the amount booked for the line campaign ($500,000) is apportioned equally among the weeks in the campaign (5 weeks), resulting in a booked amount of $100,000 per week.

In the example for Line 1, for week 1, the achieved actual GRP (0.8) of the line is less than the target GRP (1.0), indicating a weekly under-delivery. Accordingly, the actual revenue recognized by the service provider for Line 1 in week 1 is proportional to the ratio of the actual GRP (0.8) to the target GRP (1.0), that is (0.8/1.0)*($100,000)=$80,000.

Continuing with the revenue recognition for Line 1, in week 2, the achieved actual GRP (0.7) of the line is again less than the target GRP (1.0), indicating another weekly under-delivery. Accordingly, the actual revenue recognized by the service provider for Line 1 in week 2 is proportional to the ratio of the actual GRP (0.7) to the target GRP (1.0), that is (0.7/1.0)*($100,000)=$70,000.

Continuing with the revenue recognition for Line 1, in week 3, the achieved actual GRP (1.2) of the line for this week is greater than the target GRP (1.0), indicating a weekly over-delivery. Accordingly, the actual revenue recognized by the service provider for Line 1 in week 3 is proportional to the ratio of the actual GRP (1.2) to the target GRP (1.0), that is (1.2/1.0)*($100,000)=$120,000.

Continuing with the revenue recognition for Line 1, in week 4, the achieved actual GRP (1.0) of the line is equal to the target GRP (1.0). Accordingly, the actual revenue recognized by the service provider for Line 1 in week 4 is proportional to the ratio of the actual GRP (1.0) to the target GRP (1.0), that is (1.0/1.0)*($100,000)=$100,000.

In certain embodiments, invoicing is done on a monthly basis. In the example of Line 1, month 1 ends after week 4 of the campaign. Accordingly, although the campaign has a length of 5 weeks, and continues into month 2, the calculations used for the monthly invoice only include weeks 1-4 of the campaign. As such, the total revenue recognized for Line 1 for month 1 is the sum of the weekly revenues for the campaign that fall within month 1, or $80,000+$70,000+$120,000+$100,000=$370,000. Accordingly, in the example for Line 1, the service provider recognized revenue for month 1 of the campaign ($370,000) an amount less than the booked amount ($400,000) for month 1.

With regard to Week 5 of the campaign in month 2, the achieved actual GRP (1.3) of the line is greater than the target GRP (1.0). Accordingly, the actual revenue recognized by the service provider for Line 1 in week 5 is proportional to the ratio of the actual GRP (1.3) to the target GRP (1.0), that is (1.3/1.0)*($100,000)=$130,000.

The campaign for Line 1 ends after week 5, and the recognized revenue for week 5 is invoiced at the end of month 2. As described above, in certain embodiments, the service provider's monthly recognized revenue may be capped at the booked monthly amount. In other words, because week 5 is the only week of the campaign falling within month 2, the week 5 apportioned booked amount is equal to the month 2 booked amount. Therefore, while the calculated recognized amount for month 2 is $130,000, this amount is capped at booked monthly amount of $100,000.

In certain embodiments, however, a month-to-month carry under may be utilized, allowing for the recognition of monthly revenue greater than that of the booked amount. In those embodiments, the actual and target GRPs are compared on a weekly basis, and a running total carry over/under value is calculated for the month. For example, in Line 1 during month 1, the actual total GRP was less than the target total GRP, resulting in a monthly carry under GRP amount of −0.3 (see total carry over/under GRP at week 4). Accordingly, a recognized revenue corresponding to the carry under GRP value ($30,000) from month 1 may be carried under into month 2 allowing for recognition of revenue in month 2 beyond the $100,000 booked amount. Specifically, the service provider 22 could recognize revenue of $130,000 in month 2, despite the booked amount of $100,000. Accordingly, the use of a month-to-month carry under calculation allows the service provider to recognize revenue beyond that of a booked amount in a current month if revenue less than the booked amount was recognized in a previous month.

With further reference to FIG. 3a, the example of revenue recognition for Line 2 is described below. Line 2 is a campaign having a duration of 5 weeks. The target GRP for the line is 7.0. The booked campaign amount is $350,000. First, the total GRP for the line campaign (7.0) is apportioned equally among the weeks of the ad campaign (5 weeks), resulting in a weekly target GRP of 1.4. Next, the amount booked for the line campaign ($350,000) is apportioned among the weeks in the campaign (5 weeks), resulting in a booked amount of $70,000 per week.

In the example for Line 2, for week 1, the achieved actual GRP (1.1) of the line is less than the target GRP (1.4), indicating a weekly under-delivery. Accordingly, the actual revenue recognized by the service provider for Line 2 in week 1 is proportional to the ratio of the actual GRP (1.1) to the target GRP (1.4), that is (1.1/1.4)*($70,000)=$55,000.

In the example for Line 2, for week 2, the achieved actual GRP (1.5) of the line is greater than the target GRP (1.4), indicating a weekly over-delivery. Accordingly, the actual revenue recognized by the service provider for Line 2 in week 2 is proportional to the ratio of the actual GRP (1.5) to the target GRP (1.4), that is (1.5/1.4)*($70,000)=$75,000.

In the example for Line 2, for week 3, the achieved actual GRP (1.4) of the line is equal to the target GRP (1.4). Accordingly, the actual revenue recognized by the service provider for Line 2 in week 3 is proportional to the ratio of the actual GRP (1.4) to the target GRP (1.4), that is (1.4/1.4)*($70,000)=$70,000.

In the example for Line 2, for week 4, the received actual GRP (2.6) of the line is greater than the target GRP (1.4), indicating a weekly over-delivery. Accordingly, the actual revenue recognized by the service provider for Line 2 in week 4 is proportional to the ratio of the actual GRP (2.6) to the target GRP (1.4), that is (2.6/1.4)*($70,000)=$130,000.

In the example for Line 2, for week 5, the received actual GRP (0.7) of the line is less than the target GRP (1.4), indicating a weekly under-delivery. Accordingly, the actual revenue recognized by the service provider for Line 2 in week 5 is proportional to the ratio of the actual GRP (0.7) to the target GRP (1.4), that is (0.7/1.4)*($70,000)=$35,000.

With respect to invoicing, which occurs monthly, in the example for Line 2, week 5 of the campaign straddles two months, month 1 and month 2. With regard to the month to be invoiced, month 1, the first three days of week 5 are in that month. The remaining four days are in month 2. Accordingly, for invoicing for month 1, the revenue recognized for week 5 is proportional to the number of days (3) of the week that are in month 1.

With reference to FIG. 3b, there is shown an expanded view of the calculations for week 5 of Line 2. For clarity, the weekly target GRP, actual GRP, booked revenue amount and actual revenue amount are shown apportioned evenly among the seven days of the week. For example, for week 5, the target GRP (1.4) apportioned evenly among the days in the week (7) results in a daily target GRP of (1.4)/7=0.2. The actual GRP (0.7) apportioned evenly among the days in the week (7) results in a daily actual GRP of (0.7)/7=0.1. The booked amount ($70,000) apportioned evenly among the days in the week (7) results in a daily booked amount of ($70,000)/7=$10,000. The actual recognized revenue amount ($35,000) apportioned evenly among the days in the week (7) results in a daily recognized revenue of ($35,000)/7=$5,000.

As three days of week 5 fall within month 1, three times the above listed daily amounts fall within month 1. In other words, the week 5 three-day amounts included with month 1 are: a target GRP of (3)*(0.2)=0.6; an actual GRP of (3)*(0.1)=0.3; a booked amount of (3)*($10,000)=$30,000; and an actual recognized revenue amount of (3)*( $5,000)=$15,000.

Accordingly, with further reference to FIGS. 3a and 3b, for the invoicing of month 1, the revenue recognized by the service provider 22 is the sum of the recognized revenue of each of the weeks falling entirely within month 1 (weeks 1-4), plus the apportioned amounts of week 5 falling within month 1. Therefore, the total recognized revenue for month 1 is $55,000+$75,000+$70,000+$130,000+$15,000=$345,000. However, because total revenue recognized for the month by the service provider is capped at the booked amount ($70,000+$70,000+$70,000+$70,000+(3/7)*($70,000)=$310,000), and the calculated monthly recognized amount ($345,000) exceeds the booked amount, the total monthly recognized, and thus invoiced, amount will be capped at the booked amount of $310,000.

However, in the present embodiment, because the total monthly GRP (being calculated in a similar manner to that of the recognized revenue) is 1.1+1.5+1.4+2.6+0.7(3/7)=6.9, which is greater than the target monthly GRP of 1.4+1.4+1.4+1.4+1.4(3/7)=6.2, the total over-delivered GRP amount (6.9−6.2=0.7) may be carried over to the next month. It should be noted that alternate embodiments may be implemented wherein the monthly recognized revenue is not capped at the booked value and/or where no carry over or carry under calculations are employed.

With regard to the revenue recognition for the last four days of Week 5 of the campaign in month 2, in those days, the achieved actual GRP (0.4) of the line is less than the target GRP (0.8). Accordingly, the actual revenue recognized by the service provider for Line 1 in the last four days of week 5 is proportional to the ratio of the actual GRP (0.4) to the target GRP (0.8), that is (0.4/0.8)*($40,000)=$20,000.

The campaign for Line 2 ends after week 5, and the recognized revenue for the last four days of week 5 ($20,000) is invoiced at the end of month 2. In certain embodiments, however, as described above, a month-to-month carry over may be utilized, allowing for the recognition of monthly revenue greater than that of the booked amount. In those embodiments, the actual and target GRPs are compared on a weekly basis, and a running total carry over/under value is calculated for the month. For example, in Line 2 during month 1, the actual total GRP was greater than the target total GRP, resulting in a monthly carry over GRP amount of +0.7 (see FIG. 3b, total carry over/under GRP at first 3 days of week 5).

Accordingly, a recognized revenue corresponding to the carry over GRP value from month 1 (0.7) divided by the weekly target GRP (1.4) times the weekly booked amount ($70,000), or (0.7)/(1.4)*($70,000)=$35,000 from month 1 may be carried over into month 2 allowing for recognition of revenue in month 2 beyond the $20,000 booked amount. Specifically, the service provider 22 could recognize revenue of $20,000+$35,000=$55,000 in month 2, despite the booked amount of $20,000. Accordingly, the use of a month-to-month carry over calculation allows the service provider to recognize revenue beyond that of a booked amount in a current month if revenues more than the booked amount could have been recognized in a previous month, if not for a monthly cap of revenue recognition.

With respect to month 2 in the present example, the monthly cap would be the booked value for the four days of week 5 falling within month 2, or ($10,000)*(4)=$40,000. Accordingly, if a cap is applied (and/or no carry-over allowed), the recognized revenue amount of $55,000 for month 2 would be capped at $40,000.

In certain embodiments, the service provider provides the advertising client with additional discounts based upon total dollar amounts, frequent customer status, or other factors. Accordingly, with such discounts being applied, the revenue recognized by the service provider 22 would be less than the ratio of the actual GRP to target GRP. For example, if a 15% discount (i.e., a multiplier of 0.85) were given, the recognized revenue would be calculated as [(actual GRP)/(target GRP)]*(booked amount)*(0.85).

As can be seen from the above examples, GRP and recognized revenue, as well as other parameters may be calculated separately for each line of a contract. The lines may be part of the same ad campaign, or of different ad campaigns. Individual lines in a contact may each start and stop at different times and may exist within one or more months.

Furthermore, while embodiments of the invention have been described above in which weekly logical time periods and a monthly billing period are employed, certain embodiments can employ logical time periods of other durations, such as, by way of non-limiting example, a day, or a two-week period. Similarly, billing periods of a length other than a month may also be employed.

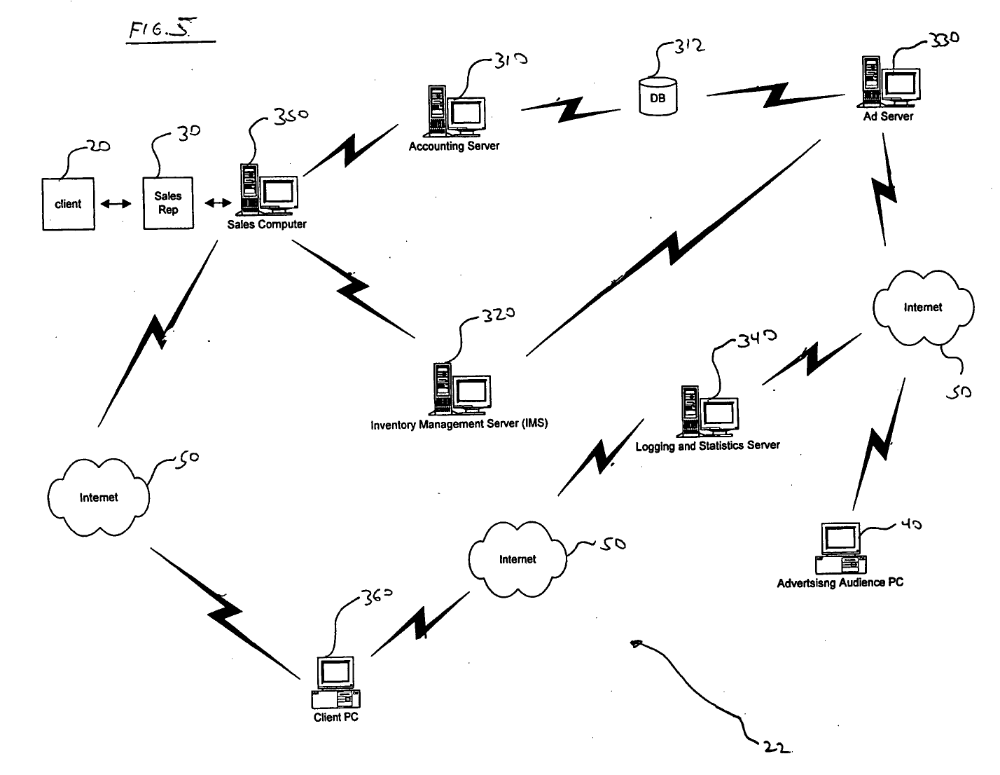

Referring to FIG. 4, components used by service provider 22 for implementing and supporting certain embodiments of the above methods are shown. Service provider 22 uses a system comprising an inventory management server 320, an ad server 330, a Logging and Statistics server 340, and an accounting server 310.

The Inventory Management Server 320, by way of historical data and predictive algorithms, provides predictions regarding the results of an advertising campaign. By way of non-limiting example, Inventory Management Server 320 may provide predictive analysis regarding various advertising metrics 321, such as analysis regarding the number of page views of an ad or combination of ads that will be viewed during an ad campaign, the number of click-throughs that will result from the ad campaign, the number of acquisitions obtained, and a predictive calculation of the resultant GRP of the ad campaign.

The Ad Server 330 provides management of stored ads for display via the Web. The Ad Server provides a variety of ad management tasks 331, such as, for example, keeping a listing of all available ads, maintaining information regarding the content of the various ads, scheduling the ads based on requirements of the particular ad campaign, as well as other related information, and display of the ads, as necessary to provide for the best results for the client.

The Logging and statistics server 340 keeps track of advertising related metrics such as, for example, the number of actual page views, the number of actual click-throughs, and the number of actual acquisitions. The accumulated values stored by Logging and Statistics Server 340 may be subsequently used by the Inventory Management Server 320 to aid in the prediction of future ad campaign results

The Accounting Server 310 performs calculations directed to the calculation of certain accounting metrics 311 such as, for example, the differences between GRP paid for by the client and actual GRP delivered, whether an over-delivery or under-delivery situation has occurred, and whether and to what extent a carry-over amount may exist. To perform the calculations, Accounting Server 310 may receive data from the Sales/Op computer 350 as well as the Inventory Management Server 320. In an embodiment of the invention, data received by Accounting Server 310 includes a “LineID” field, a “Week” field, a “ReachPercent” field, an “AvgFreq” field and a “GRP” field.

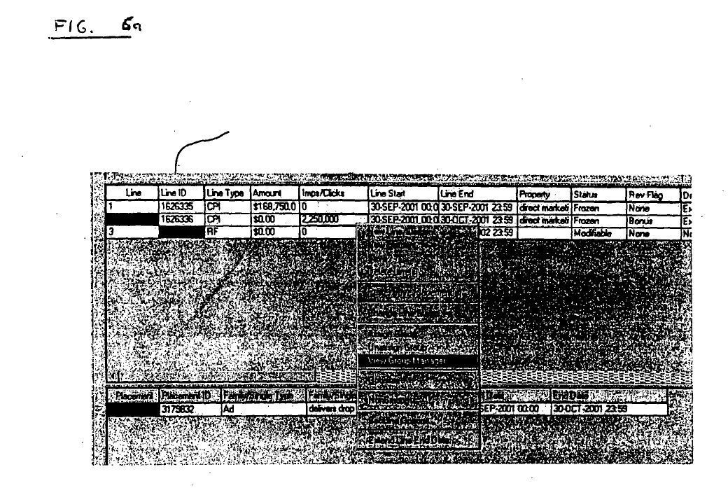

Having described the general system components, a more detailed system diagram of an embodiment of an advertising system used by service provider 22 in accordance with the present invention will now be described with reference to FIG. 5. A client 20, representing a company seeking to advertise approaches a sales rep 30 of the service provider 22 to discuss marketing needs, products, target audience, and other advertising characteristics regarding the marketing campaign. Decisions regarding the advertising campaign are made, and an order containing one or more lines is entered into the Sales/Op system 350 as is described in further detail below.

In one embodiment, advertising client 20 accesses a software program located at Sales/Op computer 350 via the Web 50 by accessing a secure Web site on client computer 360. In such embodiment, instead of the Sales Rep. 30 entering pertinent advertising campaign data into Sales/Op computer 350, the client 20 enters the information directly by accessing a secure Web site from client computer 360. In other embodiments, the Sales Rep. 30 enters the information.

Once the advertising campaign is booked and configured at Sales/Op computer 350, pertinent information is communicated to Ad Server 330. Ad Server 330 may provide management of stored ads for display via the Web. The Ad Server manages various Web ads, which may be stored at database 312. Ad Server 330 maintains a listing of all available ads, maintains information regarding the content of the various ads, performs the scheduling of the ads based on requirements of the particular ad campaign, and performs the necessary functions so that ads are displayed to the appropriate advertising audience (e.g., serves the ads to the audience).

Members of the advertising audience, each using their own advertising audience computer 40, may access various Web sites via the Web and be exposed to the ads delivered (or “served”) by Ad Server 330. As ads are served by Ad Server 330, and members of the advertising audience are exposed to the ads, the Logging and Statistics Server 340 records data regarding the amount and nature of those exposures. For example, the Logging and Statistics Server 340 may keep track of the number of actual page views, the number of actual click-throughs, and the number of actual acquisitions. Such information may be obtained by using cookies stored in the advertising audience computer 40 or based on personal information collected when the audience member registers with a service provider, such as Yahoo.com. In embodiments of the invention, the advertising client 20 accesses data recorded by the Logging and Statistics Server 340 and pertaining to his or her advertising campaign by accessing a secure Web site over the Internet via the client computer 360. In this manner, advertising client 20 may keep apprised of the effectiveness of a particular marketing campaign while the campaign is in progress.

The accumulated values stored by Logging and Statistics Server 340 may be subsequently used by the Inventory Management Server 320 to aid in the prediction of future ad campaign results. The Inventory Management Server 320, by way of historical data and predictive algorithms, provides predictions regarding the results of an advertising campaign. The Inventory Management Server 320 may provide predictive analysis regarding the number of page views of an ad or combination of ads that will be viewed during an ad campaign, the number of click-throughs that will result from the ad campaign, the number of acquisitions obtained, and a predictive calculation of the resultant GRP of the ad campaign. The predictive information provided by the Inventory Management Server 320 may be used by the Sales/Op Computer (or server) 350 in formulating a particular advertising campaign. Specifically, a Sales Rep. 30, using the Sales/Op Computer 350 can employ the predictive data from the Inventory Management Server 320 to make decisions regarding the advertising campaign in view of the particular marketing needs, products, target audience, and other requirements of the client regarding the advertising campaign.

As audience members 40 access or visit certain Web pages, Logging and Statistics Server 340 collects certain information regarding the visits. By way of non-limiting example, collected information can include the date and time of a visit, what Web pages and/or ads were viewed, and information regarding the audience member 40 such as a Yahoo! ID, if available and information from a “cookie” located on the computer of the audience member 40. If a particular audience member 40 is a registered user, having, for example, a Yahoo! ID, information from a Registration database related to the ID may be added to the Information Management Server 320. This information can include, by way of example, gender, and demographic area, country and/or Designated Market Area (“DMA”). For audience members 40 who are not registered, the Inventory management Server 320 performs an estimate or extrapolation by, for example, assuming that the various parameters of user information for unregistered users will exist in the same proportion as that of registered audience members 40. For example, if 30% of the registered users within a region or DMA are older than 40 years of age, for the purpose of these calculations, the Inventory Management Server 320 will assume that 30% of the unregistered users within that certain region or DMA are also older than 40 years of age.

In certain embodiments, the Information Management Server processes the collected information regarding the audience members 40 on a weekly basis. From that information, various statistics are calculated, including, by way of example, 1) the number of unique visitors for each group of age, gender, region and/or country, 2) the number of unique visitors between every intersection between any specific two Web properties, and 3) the number of unique visitors over the period of two consecutive weeks.

In certain embodiments, the Reach can be calculated as being equal to the number of unique visitors, and one week can have a frequency of 1. In other words, Accordingly, by way of the collected information, a GRP may then be calculated as the product of reach and frequency per line or per property, over any number of consecutive weeks.

The Accounting Server 310 facilitates the preparation of billing information for the advertising client. The Accounting Server 310 is coupled to, and transfers information with, both the Sales/Op computer 350 and Logging and statistics Server 340. As described in greater detail above, by using information from these servers regarding a particular ad campaign, the Accounting Server 310 performs calculations directed to the differences between GRP paid for by the client and actual GRP delivered, whether an over-delivery (i.e., the service provider exceeds the target GRP) or under-delivery situation has occurred, and whether and to what extent a carry-over amount may exist. As described above, tracking such information and the structure of the ad campaign allows for billings that are considered to be fair by both the advertising client and the service provider to be achieved.

In accordance with embodiments of the present invention, each server as described herein may comprise either a single server or a plurality of servers, as a routine matter of design choice, having general purpose software and special purpose software installed thereon and operable in connection with a processor thereof, provide the functionality of the present invention, as described in more detail herein. The general purpose software may include, by way of non-limiting example, operating system software, database software, communication software, security software, and other types and categories of software that may be necessary or useful to enable the server to connect to the Internet and provide the functionality of a server, as is generally known to persons skilled in the art. The general-purpose software just described is illustrative and non-limiting. It would be obvious to persons skilled in the art that other software may be provided on the server, as a routine matter of design choice.

In addition, operations described herein as being performed on different servers may, in accordance with embodiments of the present invention, be performed on the same server. Likewise, operations described herein as being performed on a single server may, in accordance with the present invention, be performed on multiple servers, and information described as flowing amongst and between the various servers over specific communication paths may flow in other and different communication paths in accordance with embodiments of the invention.

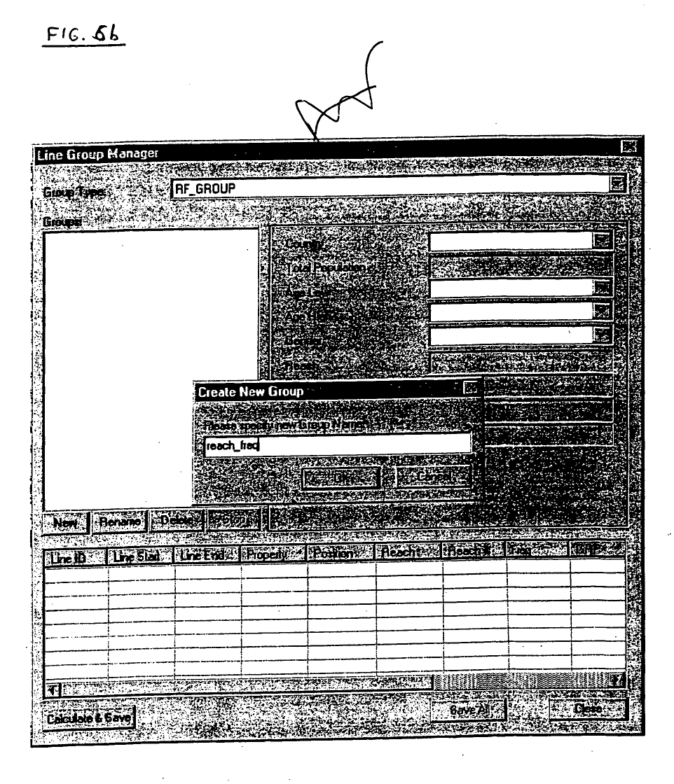

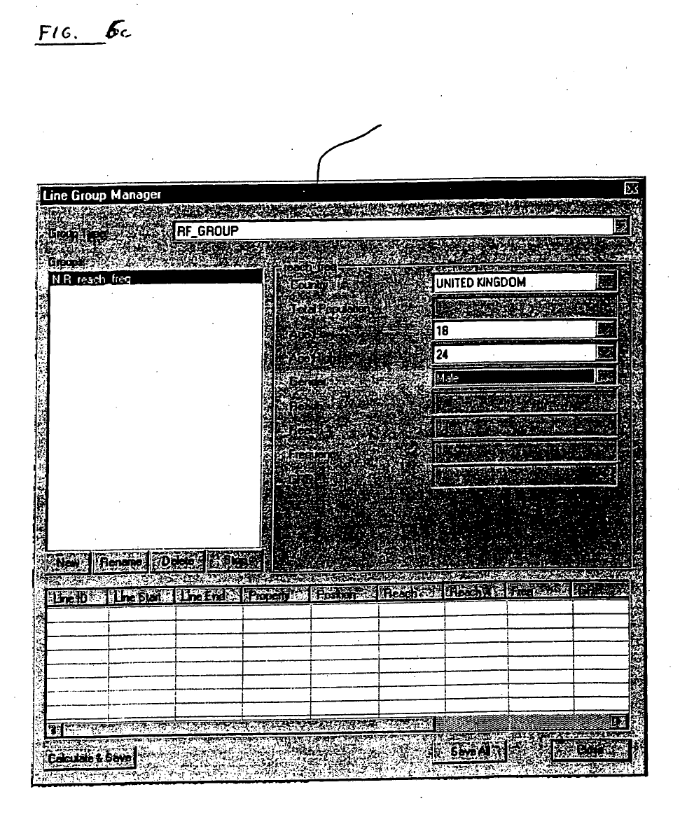

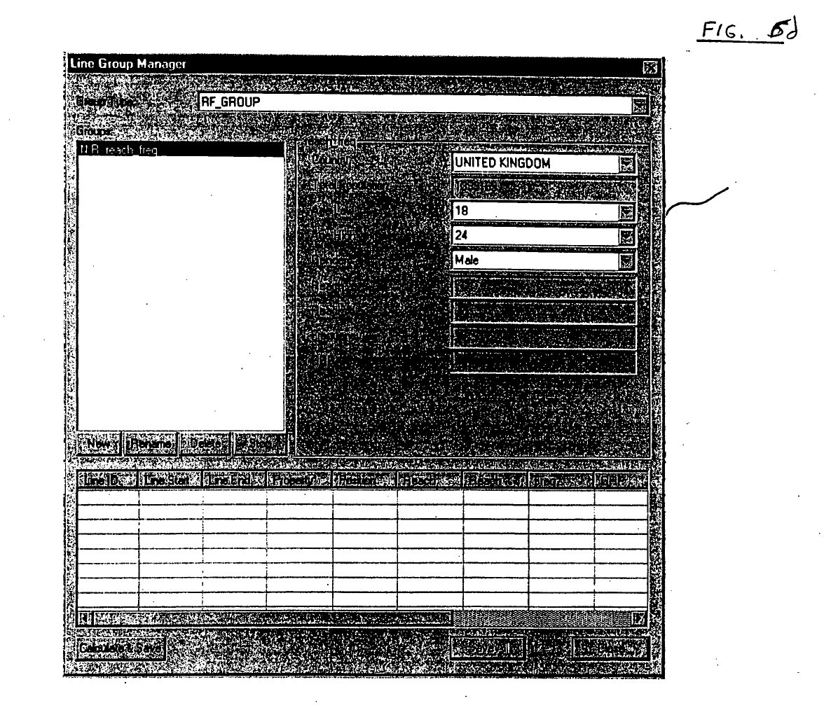

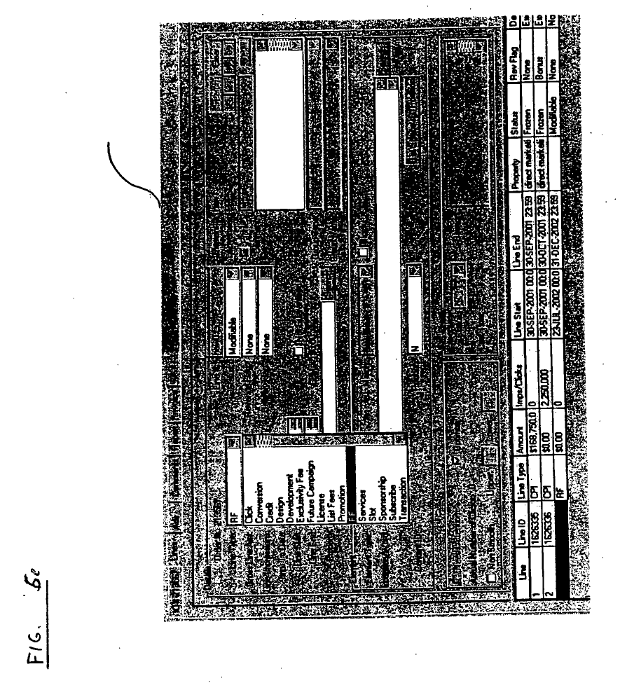

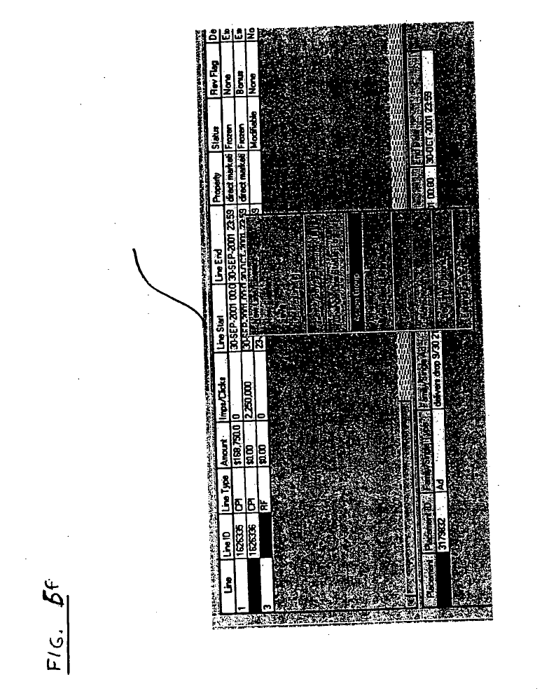

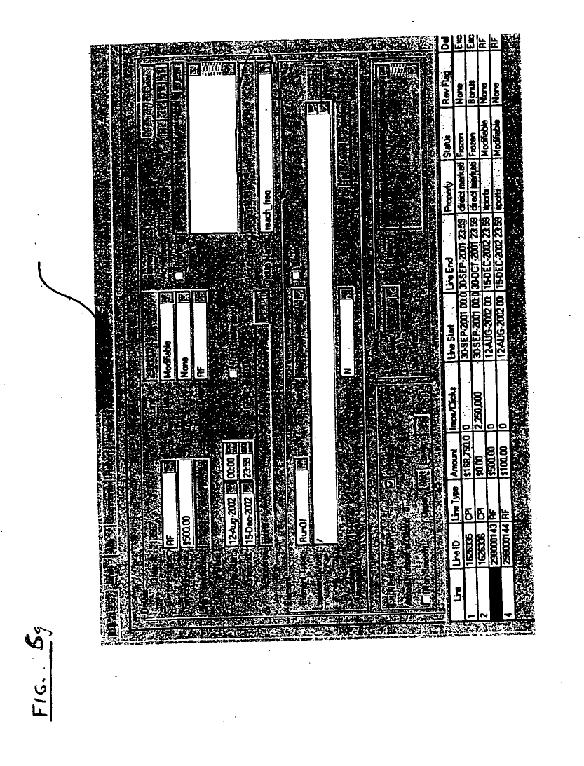

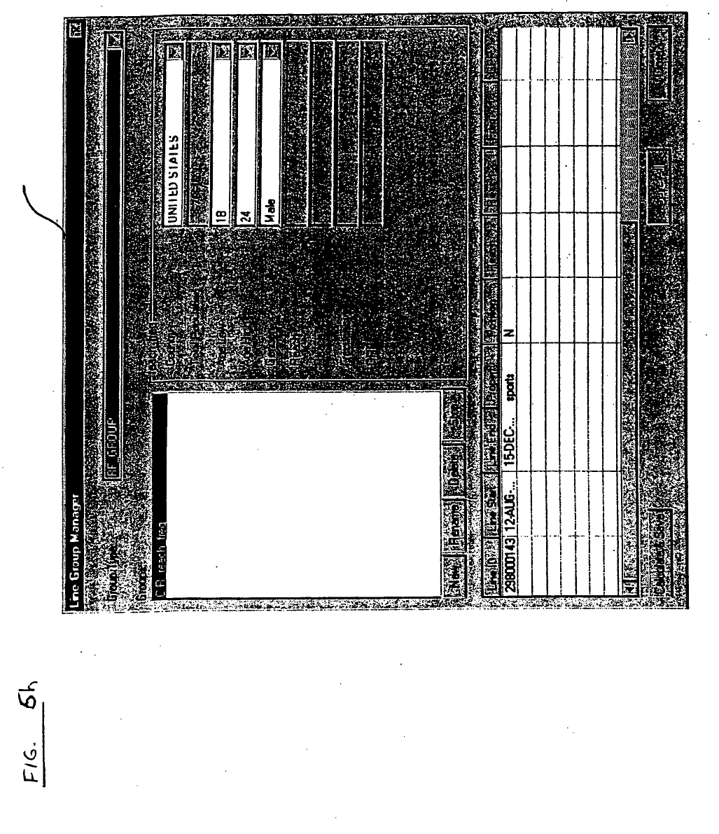

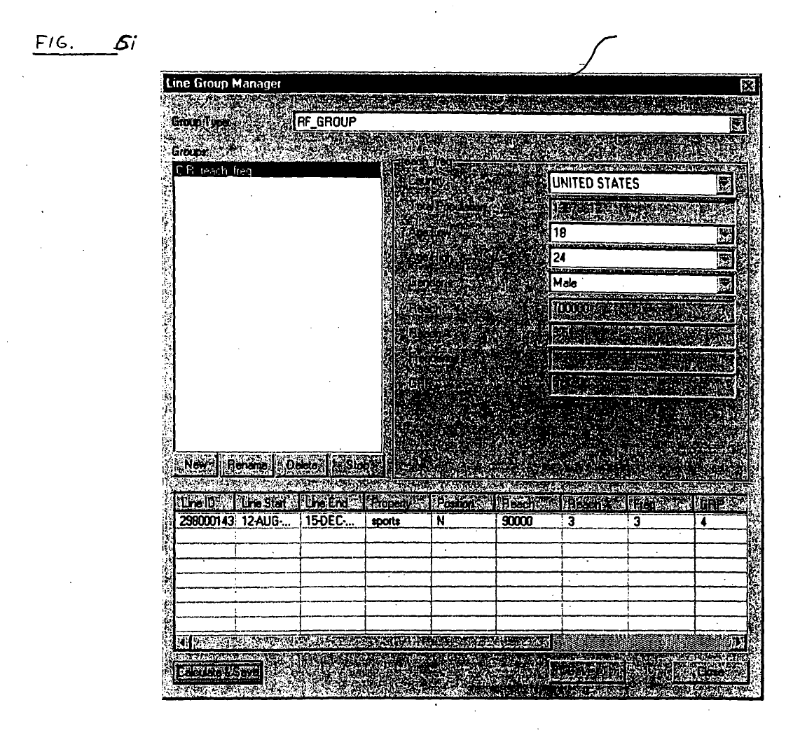

With reference to FIGS. 5 and 6a-6i, there will be discussed an embodiment of the present invention in which an ad campaign is scheduled and configured at the Sales/Op computer 350. Typically, a client 20 that wants to advertise its products meets with a Sales Rep. for the Service Provider. In general, as described above, an advertising Reach and Frequency (RF) campaign, in accordance with the present invention, may comprise a group of RF lines. There may be one or more such groups within the same Web advertising contract, also known as an Insertion Order (IO). Further, there may be one or more RF lines within an RF group. First, a user may create a new RF group. The group may be related to a specific country, and to specific audience demographics. Next, a user may create one or more RF lines to be associated with the RF group. Once RF lines are created, an RF group is assigned to each line.

In general, the goal of any particular RF campaign is to reach certain percentage of a target population in a given territory, for example a country, (Reach percentage) and thereby achieve a certain GRP score. Because one or more lines together are used to deliver the desired goal, those lines are grouped together within the same RF group. The grouping of lines to accomplish a desired GRP target is described in further detail below.

In FIG. 6a there is illustrated an exemplary screen shot depicting the creation of an RF group. While the cursor is in the line ID grid, the “View Group Manager” option may be selected.

With reference to FIG. 6b, there is illustrated an embodiment of a screen shot depicting the further creation of a new RF group. At this point, the “Group Manager” dialog box is displayed by the system. Group Type=“RF Group” and “New” may be selected to create a new RF group. A name for the new group may then be entered.

Various metrics or advertising characteristics regarding the planned campaign, including the demographics of the target audience, may be entered, as is depicted in the screen shot illustrated in FIG. 6c. This may be accomplished by selecting the target country and target demographics.

As is shown in FIG. 6d, the total population of the target population may then be calculated by selecting the “Calculate & Save” function. The total population of the target population in the specified country is then calculated. This calculation may be performed by the Sales/Op computer based in part on information provided by the inventory management server 320. This completes the creation of an RF group, in accordance with an embodiment of the present invention.

Accounting Server 310 does not calculate advertising characteristics such as Reach, Reach Percentage, Frequency and GRP values at this point, because formulas for the calculation of those values are a function of line properties, positions, and dates, and at this point in the process, no lines have been associated with the newly created RF group.

With reference to FIG. 6e, there is shown the creation if a new RF line within an advertising campaign. An RF line is then created and entered. Advertising characteristics related to the line may be entered as dictated by the predictive results provided by Inventory Management Server 320.

Next, with reference to FIG. 6f, there is depicted the assigning of an RF group to one or more RF lines. First, an RF line is selected from the lines grid (“Lines” tab) and the “Assign Group” option is selected. One of the existing RF groups may then be assigned to one of the RF lines via the “Group Manager” dialog.

FIG. 6g further depicts the assigning of a group to an RF line. As shown, a different group can be assigned to an RF line directly from the Lines tab screen by selecting the name from the “Group Name” drop-down box.

With reference to FIG. 6h, there is shown the viewing of details of an RF group and its member lines. Once one or more RF lines have been assigned to an RF group, the group and line information pertaining to Reach and Frequency may be viewed. To do so, the particular RF group may be selected from the Group Manager dialog. Information displayed may include what RF lines are members of the selected group, start/end dates, properties and positions corresponding to these lines.

As depicted in FIG. 6i, various advertising characteristics or metrics, such as Reach, Reach Percentage Frequency and GRP, related to the RF group and its associated lines may be calculated and saved. This is done by selecting a “Calculate & Save” option. The GRP displayed for the group is the net goal for this RF campaign.

It is to be understood that, as applied to certain embodiments, the calculations of GRP when proceeding from a weekly calculation to a total campaign goal is linear. Accordingly, advertisers may have confidence that they are being fairly treated by the revenue calculation system of the present invention. A mathematical proof of linearity is as follows, where C_{grp} means Cumulative GRP; C_{AvgFreq} means Cumulative Average Frequency; and C_{grp} (N) means Cumulative GRP over N weeks.

By definition:

$$GRP = AvgFreq * \frac{Reach}{Population} = AvgFreq * Reach \%$$

Proving the following equation shows linearity.

$${C}_{grpN} = {\sum }_{i = 1}^{N} {GRP}_{i} .$$

The proof is as follows:

$$\begin{matrix}{C}_{grp} ( N ) = {C}_{AvgFreq} ( N ) * \frac{{C}_{Reach} ( N )}{Population} & \begin{matrix}( by definition of GRP \\ over N units )\end{matrix} \\ = \frac{{C}_{TotalHits} ( N )}{{C}_{Reach} ( N )} * \frac{{C}_{Reach} ( N )}{Population} & \\ = \frac{{C}_{TotalHits} ( N )}{Population} & \\ = \frac{1}{Population} {\sum }_{i = 1}^{N} TotalHits ( i ) & \\ = \frac{1}{Population} {\sum }_{i = 1}^{N} 1 * Reach ( i ) & \begin{matrix}( every week the frequency \\ is defined to be 1 )\end{matrix} \\ = {\sum }_{i = 1}^{N} 1 * \frac{Reach ( i )}{Population} & \\ = {\sum }_{i = 1}^{N} 1 * Reach \% ( i ) & \\ = {\sum }_{i = 1}^{N} GRP ( i ) & ( by definition )\end{matrix}$$

The relationship between cumulative GRP of a line and the cumulative GRP of a campaign is further shown as follows.

For an RF Campaign that consists of N Lines, it can be proven that at any time of the campaign:

$$Cumulative GRP of Campaign = {\sum }_{i = 1}^{N} Cumulative GRP of Line i$$

The proof is as follows, where: CGRP means Cumulative GRP of Campaign C; LGRP(i) means Cumulative GRP of Line I; RC means Cumulative Reach of Campaign; RL(i) means Cumulative Reach of Line I; RL%(i) means Cumulative Reach Percentage of Line i; and Total Hit(i) means Total Hits of Line i.

$$\begin{matrix}\begin{matrix}CGRP = [ AvgFreq ] * [ Campaign Cumulative Reach \% ] \\ = \frac{Total\_Hits}{RC} * \frac{RC}{Population} \\ = \frac{Total\_Hits}{Population} \\ = \frac{{\sum }_{i = 1}^{N} Total\_Hits ( i )}{Population} = {\sum }_{i = 1}^{N} \frac{Total\_Hits ( i )}{Population} \\ = {\sum }_{i = 1}^{N} ( \frac{Total\_Hits ( i )}{Population} * \frac{RL ( i )}{RL ( i )} ) \\ = {\sum }_{i = 1}^{N} ( \frac{Total\_Hits ( i )}{RL ( i )} * \frac{RL ( i )}{Population}\end{matrix} & ( by definition ) \\ \begin{matrix} = {\sum }_{i = 1}^{N} AvgFreqL ( i ) * RL \% ( i ) \\ CGRP = {\sum }_{i = 1}^{N} LGRP ( i )\end{matrix} & ( by definition )\end{matrix}$$

Accordingly, by summing the cumulative GRP of the lines of the campaign, the cumulative GRP of the campaign may be obtained.

Thus the systems and methods for conducting an advertising campaign as described herein may facilitate booking, revenue recognition, management and/or billing of a Web advertising campaign. The Web advertising campaign is conducted such that the related revenue calculations are consistent, fair and meaningful to client advertisers. In addition, the advertising campaign may be booked in a manner similar to that of advertising campaigns in traditional media, to which advertising clients have become accustomed. Accordingly, advertising customers and service providers may both profit from use of a method and system in accordance with the present invention.

While the invention has been described in conjunction with certain embodiments thereof, various modifications and substitutions can be made thereto without departing from the spirit and scope of the present invention. The invention has only also been described with reference to examples, which are presented for illustration only, and thus no limitation should be imposed. Accordingly, the scope of the present invention is to be governed by the claims appended hereto.

1. A method of recognizing revenue for an Internet advertising campaign, the method comprising:
specifying a target Gross Rating Point (GRP) for one or more lines of the advertising campaign;
specifying a total booked amount for the lines;
apportioning the target GRP among one or more time periods of the campaign; and
apportioning the total booked amount among the time periods, wherein recognized revenue is based on the apportioned GRP and the apportioned booked amount.

2. The method of claim 1, wherein the target GRP is apportioned equally among the time periods.

3. The method of claim 1, wherein the booked amount is apportioned equally among the time periods.

4. The method of claim 1, further comprising:
determining the actual GRP achieved for the time periods; and
determining recognized revenue for the time periods such that a ratio of the recognized revenue to the total booked amount is based on a ratio of the actual GRP to the target GRP.

5. The method of claim 1, further comprising serving advertisements on one or more Web pages in accordance with campaign parameters.

6. The method of claim 4, wherein the ratio of recognized revenue to the total booked amount equals the ratio of the actual GRP to the target GRP for the lines.

7. The method of claim 4, wherein the ratio of recognized revenue for a particular time period to the total booked amount for a particular line is equal to the ratio of actual GRP for the particular time period to the target GRP for the particular line.

8. The method of claim 1, further comprising:
determining an invoice amount for a billing period, the invoice amount being calculated by adding recognized revenue for the lines for the time periods falling within the billing period.

9. The method of claim 8, wherein the adding recognized revenue comprises adding recognized revenue for time periods falling entirely within the billing period.

10. The method of claim 9, wherein the adding recognized revenue further comprises:
adding revenue for a particular time period that falls partially within the billing period based on an amount of time that the particular time period falls within the billing period

11. The method of claim 8, wherein the time period is a week.

12. The method of claim 8, wherein the billing period is a month.

13. The method of claim 11, wherein the time period is a week.

14. The method of claim 8, further comprising capping the invoice amount for a line to an amount for the line for the billing period.

15. The method of claim 2, further comprising, when a total actual GRP for a billing period for a particular line differs from a total target GRP for the particular line for the billing period, applying the difference between the total actual GRP and the total target GRP for the billing period to a subsequent billing period.

16. The method of claim 2, further comprising, when the total actual GRP for the billing period for a particular line is less than the total target GRP for the particular line for the billing period, applying the difference between the total actual GRP and the total target GRP to a subsequent billing period.

17. The method of claim 1, wherein each of the lines is related to an individual Web property.

18. The method of claim 1, wherein each of the lines has an associated target GRP.

19. The method of claim 13, wherein any difference between an actual weekly GRP and a target weekly GRP is automatically carried over to the subsequent week, if the subsequent week is within the same calendar month.

20. The method of claim 15, wherein the difference is calculated for each of the lines of the campaign.

21. The method of claim 1, wherein recognized revenue is separately calculated for each of the lines.

22. The method of claim 8, wherein the billing period of each of the lines is independent of the other lines.

23. A computer system for recognizing revenue for an Internet advertising campaign, the system comprising:
one or more computers configured to:
identify a target Gross Rating Point (GRP) for one or more lines of the advertising campaign;
determine a total booked amount of money for the lines;
determine an apportionment of the target GRP among one or more time periods of the campaign for the lines;
identify an apportionment of the total booked amount among the time periods; and
determine revenue based on the apportioned GRP and the apportioned booked amount.

24. The system of claim 23, wherein the computers are further configured to:
determine the actual GRP achieved for each of the time periods; and
determine recognized revenue for the time periods such that a ratio of the recognized revenue to the total booked amount is based on a ratio of the actual GRP to the target GRP.

25. The system of claim 23, wherein the target GRP is apportioned equally among the time periods.

26. The system of claim 23, wherein the booked amount is apportioned equally among the time periods.

27. The system of claim 24, wherein a ratio of recognized revenue to the total booked amount equals a ratio of the actual GRP to the target GRP for the lines.

28. The system of claim 24, wherein the computers are further configured to serve advertisements on one or more Web pages in accordance with campaign characteristics.

29. The system of claim 23, wherein the computers are further configured to:
determine an invoice amount for a billing period, the invoice amount being calculated by adding recognized revenue for the lines for the time periods falling within the billing period.

30. The system of claim 23, wherein the ratio of recognized revenue for a particular time period to the total booked amount for a particular line is equal to the ratio of actual GRP for the particular time period to the target GRP for the particular line.

31. The system of claim 29, wherein the adding recognized revenue is for lines falling entirely within the billing period.

32. The system of claim 31, wherein the adding recognized revenue further comprises:
adding revenue for a particular time period that falls partially within the billing period based on an amount of time that the particular time period falls within the billing period

33. A method of recognizing revenue for an Internet advertising campaign, the method comprising the steps of:
a step for identifying a target Gross Rating Point (GRP) for one or more lines of the advertising campaign;
a step for identifying a total booked amount of money for the lines;
a step for apportioning the target GRP among one or more time periods of the campaign; and
a step for apportioning the total booked amount among the time periods,
wherein recognized revenue is based on the apportioned GRP and the apportioned booked amount.

34. The method of claim 33, wherein the target GRP is apportioned equally among the time periods.

35. The method of claim 33, wherein the booked amount is apportioned equally among the time periods.

36. The method of claim 33, further comprising:
a step for determining the actual GRP achieved for the time periods; and
a step for determining recognized revenue for the time periods such that a ratio of recognized revenue to the total booked amount is based on a ratio of the actual GRP to the target GRP for the time periods.

37. A computer system for recognizing revenue for an Internet advertising campaign, the system comprising:
means for identifying a target Gross Rating Point (GRP) for one or more lines of the advertising campaign;
means for identifying a total booked amount of money for the lines;
means for identifying an apportionment of the target GRP among one or more time periods of the campaign for the lines;
means for identifying an apportionment of the total booked amount among the time periods; and
means for determining revenue based on the apportioned GRP and the apportioned booked amount.

38. The system of claim 37, further comprising:
means for determining the actual GRP achieved for each of the time periods; and
means for determining recognized revenue for the time periods such that a ratio of recognized revenue to the total booked amount is based on a ratio of the actual GRP to the target GRP.

39. A method of determining charges for an Internet campaign, the method comprising:
specifying a goal effectiveness measure for one or more portions of the campaign;
specifying a total booked amount for the portions;
apportioning the goal effectiveness measure among one or more portions of the campaign;
apportioning the total booked amount among the portions, wherein charges are based on the apportioned effectiveness measure and the apportioned booked amount.
determining the actual effectiveness measure achieved for the portions; and
determining the charges for the portions such that a ratio of the charges the total booked amount is based on a ratio of the actual effectiveness measure the goal effectiveness measure.
